(19) United States
(12) Patent Application Publication
(10) Pub. No.: US 2024/0428818 A1
(43) Pub. Date: Dec. 26, 2024

(54) AUDIO-FOCUS FOR AMBIENT NOISE CANCELLATION

(71) Applicant: GOOGLE LLC, Mountain View, CA (US)

(72) Inventors: Rajeev Nongpiur, Mountain View, CA (US); Neil Zeghidour, Paris (FR); Marco Tagliasacchi, Ruvigliana (CH)

(21) Appl. No.: 18/751,015

(22) Filed: Jun. 21, 2024

Related U.S. Application Data
(60) Provisional application No. 63/509,794, filed on Jun. 23, 2023.

(51) Int. Cl. G10L 21/0364; G10L 15/06; G10L 21/0208; G10L 21/0232; G10L 21/034; G10L 25/30

(52) U.S. Cl. CPC G10L 21/0364; G10L 15/063; G10L 21/0232; G10L 21/034; G10L 25/30; G10L 2021/02082

(57) ABSTRACT

A method including identifying an audio capture device and a target direction associated with the audio capture device, detecting first audio associated with the target direction, enhancing the first audio using a machine learning model configured to detect audio associated with the target direction, optionally, detecting second audio associated with a direction different from the target direction, and optionally, diminishing the second audio using the machine learning model.

### CROSS REFERENCE TO RELATED APPLICATION

This application claims the benefit to U.S. Provisional Application No. 63/509,794, filed Jun. 23, 2023, the disclosure of which is incorporated herein by reference in its entirety.

### BACKGROUND

Computing devices can include one or more speakers that allow the user to listen to audio and one or more microphones for sensing the user's voice. For example, a smartphone user wearing a Bluetooth headset may participate in a telephone conversation with a remote user. In another application, a user may use a headset to provide voice commands to a connected device. In another application, a user of a head mounted display may use voice commands to interact with virtual environments. The performance of applications reliant on audio detected by a microphone may be degraded in noisy environments (sometimes called ambient noise). In this case, the user may need to raise their voice significantly without guaranteeing optimal performance. Likewise, the hearing experience of the far-end conversation partner may be undesirably affected by the presence of environmental noise.

### SUMMARY

Example implementations use a machine learning model that can be configured (e.g., trained) to process directional audio. Some implementations leverage the machine learning model to perceptually enhance audio from target directions and/or focus regions. For example, the machine learning model can be configured (e.g., trained) to increase the amplitude of an audio associated with a first direction and to decrease the amplitude of an audio associated with a second direction.

In a general aspect, a device, a system, a non-transitory computer-readable medium (having stored thereon computer executable program code which can be executed on a computer system), and/or a method can perform a process with a method including identifying an audio capture device and a target direction associated with the audio capture device, detecting first audio associated with the target direction, enhancing the first audio using a machine learning model configured to detect audio associated with the target direction, optionally, detecting second audio associated with a direction different from the target direction, and optionally, diminishing the second audio using the machine learning model.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1 illustrates a microphone system in a noisy environment according to an example implementation.

FIG. 2A illustrates a block diagram of a multi-microphone system according to an example implementation.

FIG. 2B illustrates a block diagram of an encoder-decoder system according to an example implementation.

FIG. 2C illustrates another block diagram of an encoder-decoder system according to an example implementation.

FIG. 3A illustrates a block diagram of a multi-microphone audio data collection system according to an example implementation.

FIG. 3B illustrates another block diagram of a multi-microphone audio data collection system according to an example implementation.

FIG. 4A illustrates a block diagram of a multi-microphone audio data collection system according to an example implementation.

FIG. 4B illustrates a block diagram of a multi-microphone audio data collection system according to an example implementation.

FIG. 5 illustrates a block diagram of a neural network training system according to an example implementation.

FIG. 6 illustrates another block diagram of a neural network training system according to an example implementation.

FIG. 7 illustrates another block diagram of a neural network training system according to an example implementation.

FIG. 8 illustrates another block diagram of a neural network training system according to an example implementation.

FIG. 9 illustrates another block diagram of a neural network training system according to an example implementation.

FIG. 10 is a block diagram of a method of denoising audio according to an example implementation.

FIG. 11 is a block diagram of a method of operating a neural network training system according to an example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

The performance of applications reliant on audio detected by a microphone system in a noisy environment may be degraded. Therefore, the microphone system can include some form of audio denoising system within the microphone system. Alternatively, existing audio denoising systems use two or more microphones where a first microphone is used to detect desired audio and a second microphone to detect noise. Alternatively, audio denoising systems use a plurality of microphones (e.g., multi-microphone) to enhance audio associated with spatial regions using signal-processing techniques (e.g., beamforming). The multi-microphone sound enhancement systems require the microphones to be arranged in standard geometries (e.g., linear array or circular arrays) that are tractable enough for analysis. Arranging the microphones in a standard geometry enables generation of signal processing solutions. For example, arranging the microphones in a standard geometry facilitates computing the beamforming coefficients.

At least one technical problem with these audio denoising systems is that they are physically directional, and the microphone geometries are restricted to standard geometries (e.g., proximate to the mouth). For example, in existing systems a microphone would have to be placed in a certain location with respect to user for optimal performance. Further, the location is not flexible and should be known at design time. For example, at least one technical problem with the audio denoising systems used with the current multi-microphone sound enhancement systems is that microphone geometries are restricted to the standard geometries mentioned above. Therefore, there is no flexibility in microphone geometry design.

At least one technical solution can use a model configured (e.g., trained) to augment, enhance or focus on audio from a direction of interest and diminish or ignore audio from other directions. For example, a computing device can include the model (sometimes called a machine learning model, a trained machine learning model, a machine learned model, a trained model, and the like) configured to augment, enhance or focus on audio from a direction of interest and diminish or ignore audio from other directions. Further, using the at least one technical solution the model can be trained (or optimized) by a user allowing microphone to be placed in any location desired by user. At least one technical effect of the technical solution is audio denoising system design flexibility.

Spatially based audio denoising of microphone and/or multi-microphone systems is sometimes referred to as spatial enhancement. Accordingly, example implementations provide a machine learning approach for microphone and/or multi-microphone spatial enhancement. Some implementations can have no restrictions placed on the placement of a microphone(s), the geometry of the microphone(s) and/or the shape of a wearable device including a microphone(s). In other words, example implementations can include the use of a trained model for audio denoising and/or multi-microphone sound enhancement having microphone(s) locations and/or microphone geometries in any (e.g., unrestricted) position relative to a computing device (e.g., on a wearable device). Example implementations include a model for directional audio processing. For example, the model can be trained to enhance (e.g., causes the model to focus on) the audio from the direction of interest and diminish (e.g., causes the model to ignore) from other directions. Further, in some implementations enhancing audio can include amplitude modification, joint de-reverb and/or de-noising of the audio signal.

The amplitude modification can include increasing the amplitude. The de-reverbing can include removing resonant frequencies from the audio. A resonant frequency can be a frequency at which an audio oscillates or vibrates at its highest amplitude. Accordingly, de-reverbing can include removing oscillating audio signals. The de-noising of the audio signal can include filtering the audio. For example, audio can be associated with the human voice. The human voice can be associated with a frequency range. Therefore, de-noising of the audio signal can include filtering the audio having frequencies outside of the human voice frequency range. As another example, the human voice is unlikely to have amplitude spikes at any frequency. Therefore, de-noising of the audio signal can include filtering the audio at frequencies that have an audio spike. In some implementations, de-reverbing audio and de-noising audio can be performed together or jointly.

Further, some implementations can include diminishing (e.g., using the model) the audio associated with noise (e.g., audio not associated with the direction of interest or target direction). A direction of interest can be associated with a focus region or region of interest. Therefore, the direction of interest can be associated with a range that would appear as a cone from the perspective of the audio capture device. In other words, the audio capture device could be located at the point of the and the focus region or region of interest could be located at the circle end of the cone. The focus region or region of interest could be substantially small enough that the circle end of the cone can be a point resulting in a linear direction of interest. A direction that is not the direction of interest is a different direction than the direction of interest. A direction that does not overlap the direction of interest is a different direction than the direction of interest. A direction that does not include the direction of interest is a different direction than the direction of interest.

Diminishing the audio can include decreasing an amplitude (e.g., the relative strength of sound waves) of at least one sound wave associated with the second audio, attenuating the second audio by reducing a signal strength (e.g., reducing power ratio in decibels (dB)) associated with the second audio, and/or eliminating the second audio by removing the second audio from an output of the machine learning model. In some implementations, signal strength or audio signal strength can be a power ratio measured in dB. In some implementations, the amplitude of a sound wave can be the loudness of the audio. For example, the amplitude of a sound wave can be associated with the loudness or the amount of maximum displacement of vibrating particles of the environment from the mean position of vibrating particles when the sound is produced.

Example implementations include a model for directional audio processing. For example, the model can be trained to enhance (e.g., causes the model to focus on) the audio from the direction of interest and diminish (e.g., causes the model to ignore) from other directions. For example, two audio signals, e.g., a first audio signal having a first direction and a second audio signal having a second direction, can be input to a model training system. Then the model can be trained to enhance the first audio signal to cause the system using the model to focus on audio from the first direction (e.g., a target direction) and not focus on audio from the second direction. Using the video conference use case, the model can be trained to focus on the audio from the direction of the user (e.g., conference participant) and to not focus on audio from other directions (e.g., the back side of the computer device). Focusing on the audio from the direction of the user (e.g., user 115) and not focusing on audio from other directions (e.g., the direction of arrows 125) can be referred to as audio denoising and/or audio environment denoising.

Some implementations include training a neural network to learn a diffraction of sound across audio detectors of a computing device (e.g., a wearable device, a conference computing device, and the like) from various directions. Some implementations use the trained model to perceptually enhance sound from prescribed directions and/or focus regions. Some example use cases can include devices with multiple microphones such as wearable devices, smart glasses, AR/VR headsets, smart phones, smart-displays, and/or cameras where sound for certain focus region(s) can be enhanced. Although wearable devices may be referred to throughout this disclosure, some example implementations may not be worn on a body. For example, smart phones and cameras may or may not be worn. For example, video conference systems, smart-displays, and the like can use the audio denoising systems described herein.

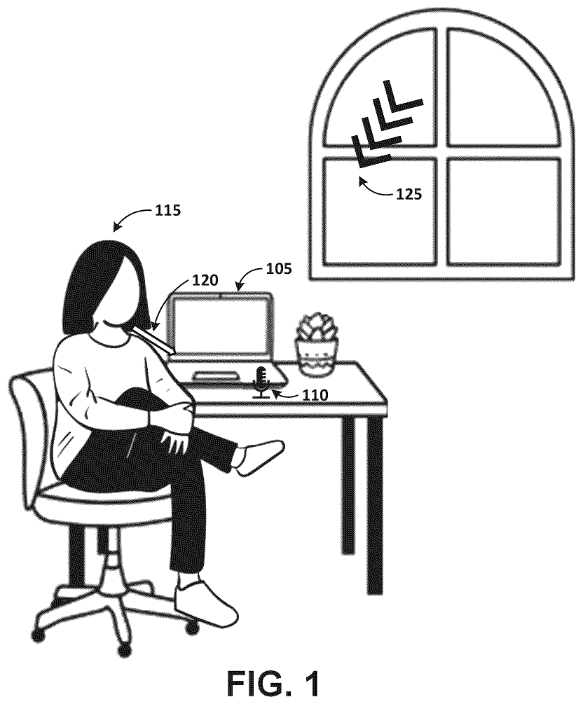

FIG. 1 illustrates a microphone system in a noisy environment according to an example implementation. As shown in FIG. 1, a computing device 105 can be communicatively coupled with (and/or include) an audio capture device 110 (e.g., a microphone(s) or any other device configured to capture analog audio). In a noiseless environment the audio capture device 110 may detect (or only detect) audio associated with user 115. However, in a noisy environment (sometimes called ambient noise), the audio capture device 110 may detect audio associated with user 115 and audio associated with the noisy environment. For example, as depicted in FIG. 1, arrow 120 can represent an audio direction associated with user 115 (sometimes referred to as a target direction) and arrows 125 can represent an audio direction associated with a noisy environment as detected by audio capture device 110. An example audio capture device 110 can include, but is not limited to, microphone(s), piezoelectric sensor(s), and capacitive sensor(s).

A typical audio denoising system can use microphones having at least two ports, a first port normally oriented toward the desired audio (e.g., audio detected from a direction associated with arrow 120) and a second port that is oriented away from the desired audio (e.g., audio detected from a direction associated with arrows 125). Alternatively, existing audio denoising systems use two or more microphones where a first microphone is used to detect desired audio e.g., audio detected from a direction associated with arrow 120) and a second microphone to detect ambient noise (e.g., audio detected from a direction associated with arrows 125). Alternatively, audio denoising systems use a plurality of microphones (e.g., multi-microphone) to enhance audio associated with spatial regions using signal-processing techniques (e.g., beamforming).

In some implementations, computing device 105 can include the model trained to augment, enhance or focus on audio from a direction of interest (e.g., audio detected from a direction associated with arrow 120) and diminish or ignore audio from other directions (e.g., audio detected from a direction associated with arrows 125). Further, the model can be trained (or optimized) by a user allowing microphone to be placed in any location desired by user. Accordingly, the audio denoising system can have a flexible design.

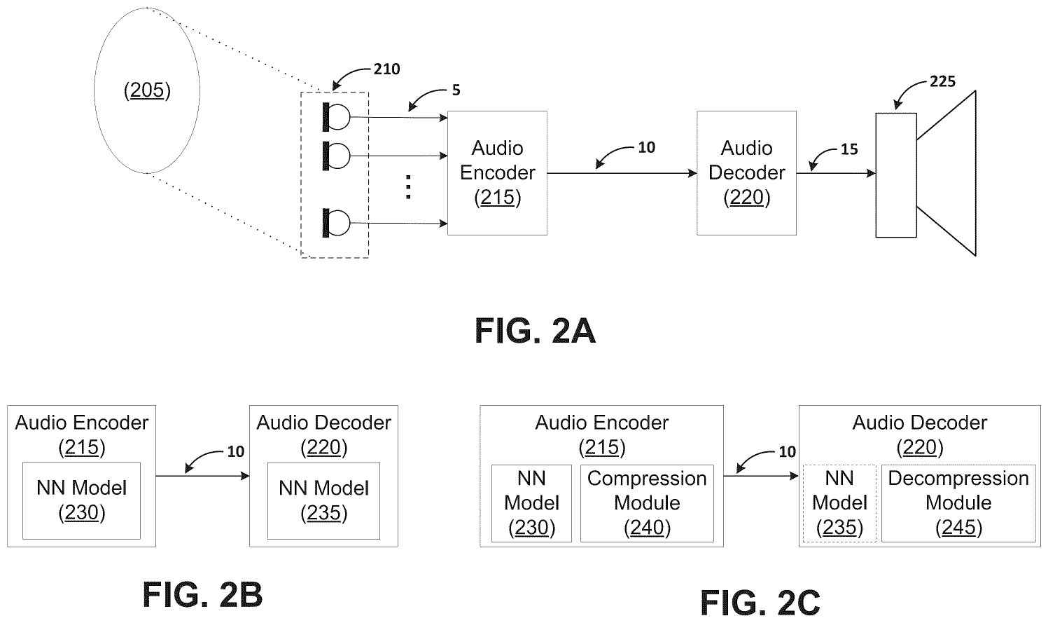

FIG. 2A illustrates a block diagram of a multi-microphone system according to an example implementation. FIG. 2B illustrates a block diagram of an encoder-decoder system according to an example implementation. FIG. 2C illustrates another block diagram of an encoder-decoder system according to an example implementation. As shown in FIG. 2A, the multi-microphone system can include a plurality of microphones 210, an audio encoder 215, an audio decoder 220, and a speaker 225 (or speakers). As shown in FIG. 2A, the audio encoder 215 can include, for example, a neural network (NN) model 230 and the audio decoder 220 can include a NN model 235. The multi-microphone system can be included in a wearable device.

As shown in FIG. 2A, the plurality of microphones 210 can detect (receive, detect, and the like) a directional audio signal 5 from a focus region 205. In some example implementations, the plurality of microphones 210 can detect a plurality of directional audio signals 5 from at least one (e.g., two or more) focus region 205. A focus region (e.g., focus region 205) can be a location in an environment (e.g., a room). The focus region can include multiple audio sources, at least partially, directed toward a microphone. A focus region can include an audio source(s) that generates audio from a range of angles directed at the microphone. In other words, the directional audio signal 5 can have a plurality of directions across a range representing a focus region.

An audio input can be compressed by an encoder or encoder neural network. The encoder neural network can be configured to process the input audio to generate a set of feature vectors representing the input audio. In some implementations, the set of feature vectors can represent compressed audio. For example, the encoder neural network can include a sequence of encoder blocks, where each encoder block is configured to process a set of input feature vectors to generate a set of output feature vectors. As part of processing the set of input feature vectors, each encoder block can perform operations to down-sample (e.g., compress) the set of input feature vectors. Thus, the set of output feature vectors generated by the encoder block includes fewer feature vectors than the set of input feature vectors received by the encoder block.

A compressed audio input can be decompressed by a decoder or decoder neural network. The decoder neural network can be configured to process the set of feature vectors (e.g., compressed audio) generated by the encoder neural network to generate an output audio. For example, the decoder neural network can include a sequence of decoder blocks, where each decoder block is configured to process a set of input feature vectors to generate a set of output feature vectors. As part of processing the set of input feature vectors, each decoder block can perform operations to up-sample (e.g., decompress) the set of input feature vectors. Thus, the set of output feature vectors generated by the decoder block can include more feature vectors than the set of input feature vectors received by the decoder block.

Convolving audio data, convolving training data, convolving audio signals and the like can include performing a convolution operation that up-samples a set of input feature vectors. In some implementations, up-sampling the set of input feature vectors can include simultaneously decreasing (e.g., halving) the dimensionality of the feature vectors. Accordingly, in some implementations, the decoder block can perform a convolution operation.

The directional audio signal 5 can be received by and compressed by the audio encoder 215. For example, the audio encoder 215 can be configured to generate a compressed audio signal 10 based on the directional audio signal 5. As shown in FIG. 2B, the audio encoder 215 can include the NN model 230. The NN model 230 can be a trained model. The NN model 230 can be configured to compress the directional audio signals 5. In some example implementations, the NN model 230 can be configured to spatially enhance the directional audio signals 5 during compression. In other words, the NN model 230 can be configured to generate the compressed audio signal 10 as a spatially enhanced compressed audio signal based on the directional audio signal 5.

As shown in FIG. 2C, the audio encoder 215 can include the NN model 230 and a compression module 240. The NN model 230 can be a trained model. In some example implementations, the NN model 230 can be configured to spatially enhance the directional audio signals 5. Compression module 240 can be configured to compress the spatially enhanced directional audio signals 5. In other words, compression module 240 can be configured to generate the compressed audio signal 10 as a spatially enhanced compressed audio signal based on the directional audio signal 5.

A spatially enhanced compressed audio signal can be an audio signal including enhanced audio corresponding to the focus region 205 (and/or multiple focus regions), while attenuating an audio signal(s) from other region(s) (e.g., the non-focus region(s)). In some implementations, the NN model 230 can be configured to (e.g., trained to) attenuate audio signal(s) from the other region(s) such that the audio signal(s) from the other region(s) are not included (or not substantially included) in the compressed audio signal 10. In other words, the audio signal(s) from other region(s) can be attenuated to have a power equal to (or substantially equal to) zero (0) such that there is no audio signal to compress. In other words, the audio signal(s) from other region(s) can be filtered (e.g., removed from) the directional audio signal 5 such that the audio signal(s) from the other region(s) are not included (or not substantially included) in the compressed audio signal 10.

The compressed audio signal 10 can be received by and decompressed by the audio decoder 220. For example, the audio decoder 220 can be configured to generate a reconstructed audio signal 15 based on the compressed audio signal 10. As shown in FIG. 2C, the audio decoder 220 can optionally include the NN model 235. The NN model 235 can be a trained model. The NN model 235 can be configured to (or trained to) optimize the compressed audio signal 10. The decompression module 245 can be configured to decompress the compressed audio signal 10 as the reconstructed audio signal 15. Speaker 225 can be configured to playback the reconstructed audio signal 15. In other words, speaker 225 can be configured to generate sound waves based on the reconstructed audio signal 15.

As shown in FIG. 2C, the audio decoder 220 can (optionally) include the NN model 235 and a decompression module 245. In some implementations, the audio decoder 220 can include the decompression module 245 without the NN model 235. The NN model 235 can be a trained model. The decompression module 245 can be configured to decompress the compressed audio signal 10 as the reconstructed audio signal 15. Speaker 225 can be configured to playback the reconstructed audio signal 15. In other words, speaker 225 can be configured to generate sound waves based on the reconstructed audio signal 15. In some implementations, the compression module 240 and the decompression module 245 can use a standard audio codec.

In some implementations, development of the NN model 230 and/or the NN model 235 can be based on collecting device related transfer functions (DRTF) and design of the augmentation and training framework. In some implementations, an audio signal can be from the user wearing the wearable device as, for example, a headset or glasses. Therefore, for some wearable devices (e.g., an AR/VR headset) mouth-to-headset transfer functions (MHTF) can be collected.

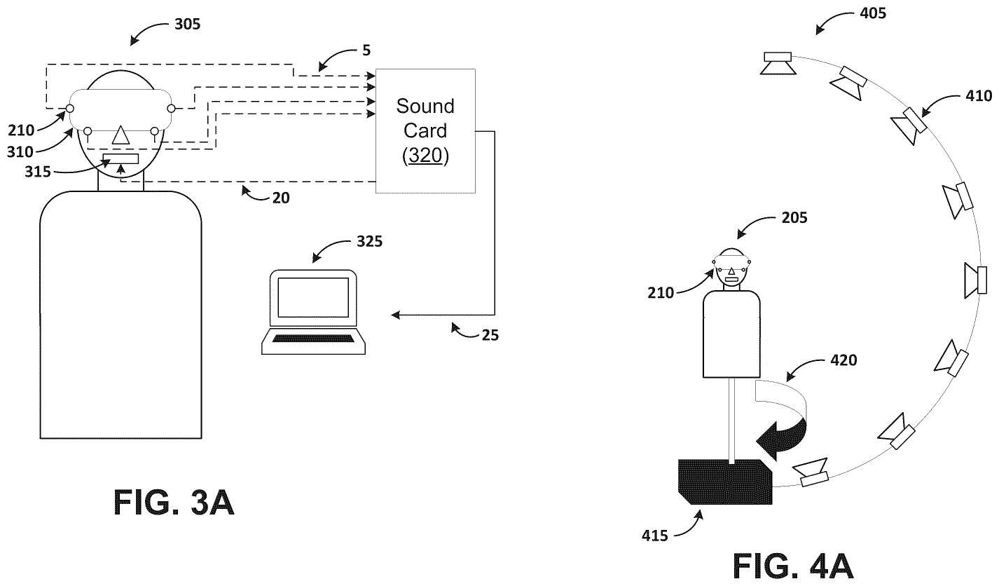

FIG. 3A illustrates a block diagram of a multi-microphone audio data collection system according to an example implementation. FIG. 3A can illustrate a block diagram of a setup for collecting the MHTFs. As shown in FIG. 3A, a head-and-torso simulator (HATS) 305 includes an attached wearable device 310 (e.g., a head worn wearable device). The wearable device 310 can include the plurality of microphones 210. The plurality of microphones 210 is illustrated as including four (4) microphones, however, some implementations can include more or less than four (4) microphones. The plurality of microphones 210 on the wearable device 310 can be arranged in a non-standard geometry. In other words, the plurality of microphones 210 can be arranged such that existing signal-processing techniques (e.g., beamforming) are not optimal for processing detected directional audio signals. In some implementations, the wearable device 310 can be configured to spatially enhance an audio signal(s) detected by the plurality of microphones 210. In other words, the wearable device 310 can include the NN model 230. The HATS 305 including the attached wearable device 310 can be placed in an anechoic chamber when collecting data.

The HATS 305 can include an artificial mouth 315. The artificial mouth 315 can include a speaker to mimic speech. A sound card 320 can be configured to generate a signal 20 configured to cause the artificial mouth 315 to generate sound waves. In some implementations, signal 20 can be a sine wave sweep. In this implementation the directional audio signal 5 can be based on signal 20. The directional audio signal 5 can be received by the sound card 320. The sound card 320 can be configured to generate audio data 25 based on the directional audio signal 5. In some implementations, a computer 325 can be configured to generate transfer functions based on the audio data 25. For example, computer 325 can be configured to generate MHTFs based on the audio data 5. In some implementations, the MHTFs can be collected and used to train the NN model 230 and/or the NN model 235. In some implementations, the HATS 305 can be placed in an anechoic chamber and the sound card 320 and computer 325 can be external to the anechoic chamber. In some implementations, the sound card 320 can be included in the computer 325. In some implementations, the sound card 320 can be included in a separate device from the computer 325.

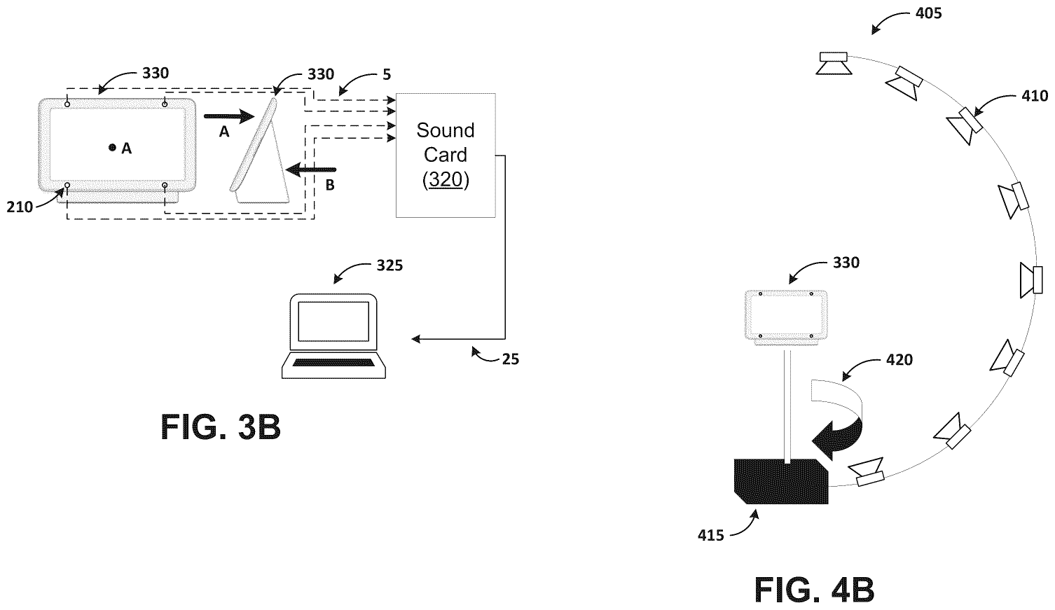

FIG. 4A illustrates a block diagram of a multi-microphone audio data collection system according to an example implementation. FIG. 4A can illustrate a block diagram of a setup for collecting the DRTFs. The audio data collection system of FIG. 4A can be configured to capture and save audio data for later training of an NN model. The captured audio data can include directional information (e.g., the direction that the HATS 305 is facing in the room).

As shown in FIG. 4A, the HATS 305 including the attached wearable device 310 can be in a room (e.g., an anechoic chamber) including a speaker fixture 405. The speaker fixture 405 can include a plurality of speakers 410. The HATS can be fixed to a rotating fixture 415 (e.g., a turntable) configured to rotate in a direction 420. Although not shown, the plurality of speakers 410 can be communicatively coupled to a sound card similar to sound card 320 and activated using a signal similar to signal 20. Further, data based on the directional audio signal 5 can be input to a computer similar to computer 325 via the sound card similar to sound card 320.

The plurality of speakers 410 can be used to simulate external sound sources. The sound card can be configured to generate a signal configured to cause the plurality of speakers 410 to generate sound waves. The signal can be a sine wave sweep. In this implementation the directional audio signal can be based on the signal. The directional audio signal can be received by the sound card. The sound card can be configured to generate audio data based on the directional audio signal. In some implementations, the computer can be configured to generate transfer functions based on the audio data. For example, the computer can be configured to generate DRTFs based on the audio data. In some implementations, the DRTFs can be collected and used to train the NN model 230 and/or the NN model 235. In some implementations, the HATS 305 can be placed in an anechoic chamber and the sound card and computer can be external to the anechoic chamber.

In some implementations, the HATS 305 can be rotated on the rotating fixture 415 to collect the DRTFs from various azimuths/elevations. To provide the option for personalizing the transfer functions and improve robustness, the HATS 305 can be configured with artificial heads of different sizes and shapes.

FIG. 3B illustrates a block diagram of a multi-microphone audio data collection system according to an example implementation. FIG. 3B can illustrate a block diagram of a setup for collecting the MHTFs. As shown in FIG. 3B, a computing device 330 (e.g., a home automation control device) can include the plurality of microphones 210. The plurality of microphones 210 is illustrated as including four (4) microphones, however, some implementations can include more or less than four (4) microphones. The plurality of microphones 210 on the computing device 330 can be arranged in a non-standard geometry. In other words, the plurality of microphones 210 can be arranged such that existing signal-processing techniques (e.g., beamforming) are not optimal for processing detected directional audio signals. The computing device 330 can be placed in an anechoic chamber when collecting data.

The computing device 330 in two perspective views in FIG. 3B. The computing device 330 on the left is illustrated in a front facing (e.g., toward a user) view and the computing device 330 on the right is illustrated in a side facing view. The two perspective views can be used to illustrate example sound wave directions. Sound wave direction A is toward the front facing side of the computing device 330. Accordingly, sound waves in direction A are directed toward the plurality of microphones 210. Sound wave direction B is toward the back side of the computing device 330. Accordingly, sound waves in direction B are not directed toward the plurality of microphones 210. Therefore, focus region 205 can be associated with sound waves received from direction A. In other words, in some implementations the directional audio signal 5 can be based on the sound waves received from direction A.

The directional audio signal 5 can be received by the sound card 320. The sound card 320 can be configured to generate audio data 25 based on the directional audio signal 5. In some implementations, a computer 325 can be configured to generate transfer functions based on the audio data 25. For example, computer 325 can be configured to generate MHTFs based on the audio data 5. In some implementations, the MHTFs can be collected and used to train the NN model 230 and/or the NN model 235. In some implementations, the computing device 330 can be placed in an anechoic chamber and the sound card 320 and computer 325 can be external to the anechoic chamber. In some implementations, the sound card 320 can be included in the computer 325. In some implementations, the sound card 320 can be included in a separate device from the computer 325.

FIG. 4B illustrates a block diagram of a multi-microphone audio data collection system according to an example implementation. FIG. 4B can illustrate a block diagram of a setup for collecting the DRTFs. The audio data collection system of FIG. 4B can be configured to capture and save audio data for later training of an NN model. The captured audio data can include directional information (e.g., the direction that the computing device 330 is facing in the room).

As shown in FIG. 4B, the computing device 330 can be in a room (e.g., an anechoic chamber) including a speaker fixture 405. The speaker fixture 405 can include a plurality of speakers 410. The computing device 330 can be fixed to a rotating fixture 415 (e.g., a turntable) configured to rotate in a direction 420. Although not shown, the plurality of speakers 410 can be communicatively coupled to a sound card similar to sound card 320 and activated using a signal similar to signal 20. Further, data based on the directional audio signal 5 can be input to a computer similar to computer 325 via the sound card similar to sound card 320.

The plurality of speakers 410 can be used to simulate external sound sources. The sound card can be configured to generate a signal configured to cause the plurality of speakers 410 to generate sound waves. The signal can be a sine wave sweep. In some implementations the directional audio signal can be based on the signal. The directional audio signal can be received by the sound card. The sound card can be configured to generate audio data based on the directional audio signal. In some implementations, the computer can be configured to generate transfer functions based on the audio data. For example, the computer can be configured to generate DRTFs based on the audio data. In some implementations, the DRTFs can be collected and used to train the NN model 230 and/or the NN model 235. In some implementations, the HATS 305 can be placed in an anechoic chamber and the sound card and computer can be external to the anechoic chamber.

In some implementations, the computing device 330 can be rotated on the rotating fixture 415 to collect the DRTFs from various azimuths/elevations. In some implementations, the directional audio signal can be collected in relation to the sound wave direction (e.g., directions A and B). In some implementations, the directional audio signal can be collected every, for example, five (5) degrees of rotation. Therefore, the directional audio signal collected in some samples associated with direction A (e.g., within 15 degrees) can be used as the focus region 205 for training the NN model 230 and/or the NN model 235.

In some implementations, the collection of the MHTFs and the DRTFs (as described with regard to FIGS. 3A, 3B, 4A and 4B) from various directions can be used to generate data for training models. DRFTs can be computed for each of the device (e.g., wearable device) microphones (e.g., the plurality of microphones 210) across various azimuths and elevations, by emitting a sine-sweep from each of the loudspeakers and then recording on the device microphones for various turntable positions. In some implementations, a dataset of DRTFs can be collected in an anechoic chamber and in rooms of different sizes with varying reverberation-times (e.g., signal responses reflections, and the like).

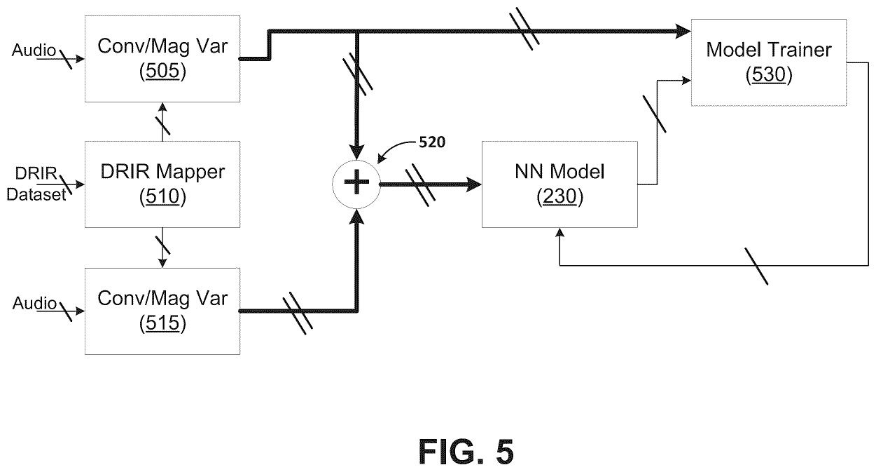

FIG. 5 illustrates a block diagram of a neural network training system according to an example implementation. As shown in FIG. 5, the neural network training system can include a convolution/magnitude variation 505 block, a directional room impulse response (DRIR) mapper 510 block, a convolution/magnitude variation 515 block, a summing 520 block, the NN model 230, and a model trainer 530 block. In the illustration of FIG. 5, the thinner lines with a single slash indicate a single channel and the thicker lines with two slashes indicate multiple channels. The dataflow associated with FIG. 5 can be an augmentation and training for audio-focus dataflow.

Audio signals in a room environment may experience various effects including scattering effects, reverberations, reflections, refractions, absorptions, or other linear or nonlinear effects. A room impulse response(s) can be a response (e.g., as detected by a microphone(s)) to an audio impulse source that takes into account the various effects of the room environment, including scattering effects, reverberation times, or other linear or nonlinear effects. At least one impulse response can be used to represent the audio signal response associated with the room, room environment, and/or environment. A plurality of impulse responses can be used to represent the audio signal response associated with the room, room environment, and/or environment. The plurality of impulse responses can be directional or have a directional component. A dataset including the plurality of impulse responses and/or the directional impulse responses can be used to represent the audio signal response associated with the room, room environment, and/or environment. Accordingly, an impulse response dataset can represent an audio signal(s) response(s) associated with the room, room environment, and/or environment. The impulse response dataset representing the audio signal(s) response(s) associated with the room, room environment, and/or environment can include directional components. The impulse response dataset representing the audio signal(s) response(s) associated with the room, room environment, and/or environment can be a directional room impulse response (DRIR) dataset.

A DRIR can be a response (e.g., as detected by a microphone(s)) to an audio impulse source that takes into account the direction or direction of arrival of the sound waves (e.g., from a source to a microphone) in addition to the various effects of the room environment, including scattering effects, reverberation times, or other linear or nonlinear effects. Accordingly, a DRIR can be a room impulse response measurement (e.g., as detected by a microphone) that takes into account direction of arrival of the sound waves generated by an audio source(s). A DRIR dataset can be a dataset of directional measurements representing the audio signal(s) response(s) associated with the room, room environment, and/or environment. A DRIR dataset can be based on impulse response measurements taken in a room, simulated impulse responses based on a room, a combination of measurements and simulations and/or a combination of measurements and calculated and/or estimated room acoustic parameters. For example, a DRIR measurement and/or DRIR dataset can be based on sound waves generated by an audio source (e.g., speaker) and measured by an audio capture device (e.g., a microphone(s)) where the directional relationship (e.g., spatial relationship) between the audio source and the audio capture device are known (or can be determined) and/or can be estimated and/or can be simulated. As discussed below, a DRIR dataset can be based on a MHTF dataset and/or a DRFT dataset.

In some implementations an audio signal can be input into each of the convolution/magnitude variation 505 and the convolution/magnitude variation 515. The audio signals can be the same (or substantially the same) audio signal or different audio signals. A DRIR dataset can be input into the DRIR mapper 510. The DRIR dataset can be a dataset including impulse responses associated with at least two types of directional audio signal 5. In some implementations, the DRIR dataset can include an MHTF dataset and a DRTF dataset. In some implementations, the MHTF dataset can correspond to a focus region (e.g., focus region 205) and the DRTF dataset can correspond to a non-focus region. For example, impulse responses generated using the system of FIGS. 2A (e.g., mouth) and 3B (e.g., direction A) can correspond to the MHTF dataset and the impulse responses generated using the system of FIGS. 3A and 3B (e.g., direction B) can correspond to the DRTF dataset. Further, the DRIR dataset input into DRIR mapper 510 can be a combination of the impulse responses generated using the systems of FIGS. 3A, 3B, 4A, and 4B.

Further, the DRIR mapper 510 can be configured to map data (e.g., impulse responses) corresponding to a focus region(s) as input to the convolution/magnitude variation 505 and to map data (e.g., impulse responses) corresponding to a non-focus region(s) as input to the convolution/magnitude variation 515. Therefore, the MHTF dataset can be input to the convolution/magnitude variation 505 and the DRTF dataset can be input to the convolution/magnitude variation 515. Further, an alternative implementation (or additional implementation) can include directly inputting the MHTF (or focus region) dataset to the convolution/magnitude variation 505 and/or directly inputting the DRTF (or non-focus region) dataset to the convolution/magnitude variation 515.

The convolution/magnitude variation 505, 515 can be configured to convolve the respective DRIR dataset with the input signal and apply random gain variations to the convolved data. The output of the convolution/magnitude variation 505, 515 are summed (summing 520) and used as input to the NN model 230. The output of the convolution/magnitude variation 505 is further used as an input to the model trainer 530. The output of the convolution/magnitude variation 505 can be used as the ground-truth for the model trainer 530. Accordingly, the data associated with a focus region(s) (e.g., the MHTF dataset) can be used as the ground-truth for the model trainer 530.

The model trainer 530 can use a cost function to train the NN model 230. In other words, the model trainer 530 can use a cost function to update coefficients associated with the NN model 230. In some implementations, the data flow of FIG. 5 can be repeated until some criterion is met. For example, the data flow of FIG. 5 can be repeated until the cost function generates a value below (or, alternatively above) a threshold value. The threshold value can be pre-defined as, for example, an input value, a value in a memory, and the like.

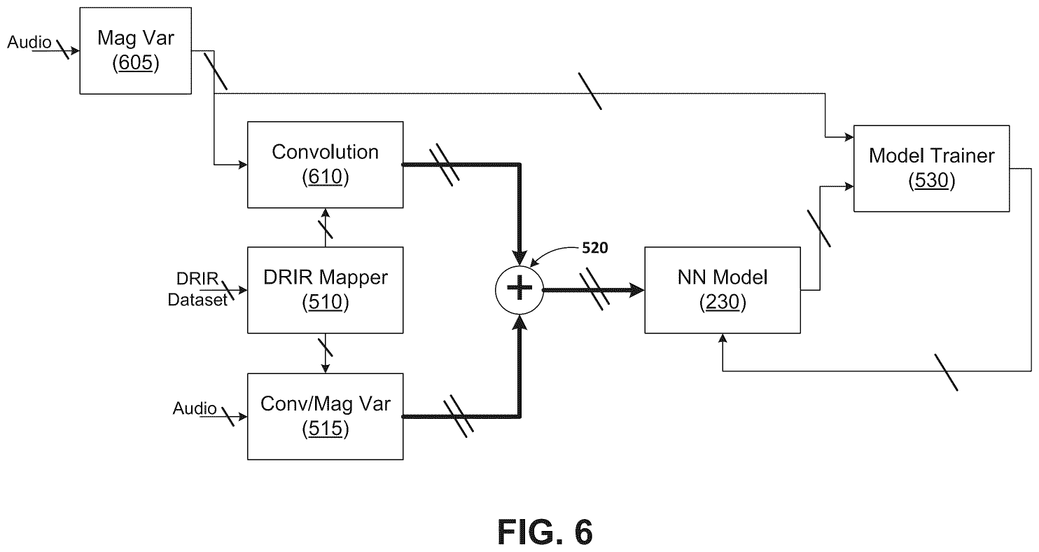

FIG. 6 illustrates another block diagram of a neural network training system according to an example implementation. As shown in FIG. 6, the neural network training system can include a magnitude variation 605 block, a convolution 610 block, the DRIR mapper 510 block, the convolution/magnitude variation 515 block, the summing 520 block, the NN model 230, and the model trainer 530 block. In the illustration of FIG. 6, the thinner lines with a single slash indicate a single channel and the thicker lines with two slashes indicate multiple channels. The dataflow associated with FIG. 6 can be an augmentation and training for audio-focus dataflow. The dataflow associated with FIG. 6 can also be a de-reverberation dataflow. The blocks described above may not be further described for the sake of brevity.

In some implementations, the objective can be to enhance audio from the focus region and to de-reverberate the output. Therefore, the system of FIG. 5 can be modified such that an input audio source can be used as the ground-truth signal. Such a modification is illustrated in FIG. 6. As shown in FIG. 6 the input audio signal is input to the magnitude variation 605 where random gain variations can be applied to the input audio signal. The output of the magnitude variation 605 can be an input to the model trainer 530 and can be used as the ground-truth for the model trainer 530. In some implementations, a level (e.g., quantity) of reverberation can be based on a distance between the audio source and the microphone. For example, the greater the distance between the audio source and the microphone the greater the level of reverberation.

The output of the magnitude variation 605 can further be an input to the convolution 610. Convolution 610 can be configured to convolve the respective DRIR dataset with the output of the magnitude variation 605. The output of the convolution 610 and the output of the convolution/magnitude variation 515 are summed (summing 520) and used as input to the NN model 230.

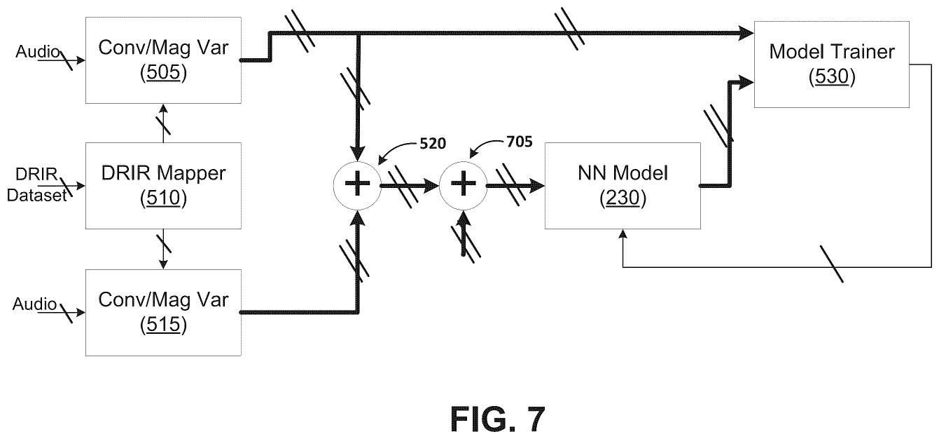

FIG. 7 illustrates another block diagram of a neural network training system according to an example implementation. As shown in FIG. 7, the neural network training system can include the convolution/magnitude variation 505 block, the DRIR mapper 510 block, the convolution/magnitude variation 515 block, the summing 520 block, a summing 705 block, the NN model 230, and the model trainer 530 block. In the illustration of FIG. 7, the thinner lines with a single slash indicate a single channel and the thicker lines with two slashes indicate multiple channels. The blocks described above may not be further described for the sake of brevity.

In some implementations, the objective can be to enhance audio from the focus region and to enhance a certain class (or classes) of audio (e.g., speech). Therefore, the system of FIG. 5 can be modified such that an additional signal can be added to the input of the NN model 230. Such a modification is illustrated in FIG. 7. As shown in FIG. 7 the output of the summing 520 is input to the summing 705. Summing 705 further includes an additional input signal. For example, the class of audio to be enhanced can be speech. Therefore, non-speech noise can be summed with (summing 705) the output of the summing 520 and the output of summing 705 can be input to NN model 230.

As shown in FIGS. 2A, 2B, and 2C, the model includes the audio encoder 215 and the audio decoder 220. Further, each of FIGS. 4A, 4B, 5, and 6 illustrate training NN model 230 Of the audio encoder 215. However, both the audio encoder 215 and the audio decoder 220 can be jointly trained in any of the configurations of FIGS. 4, 5, and 6.

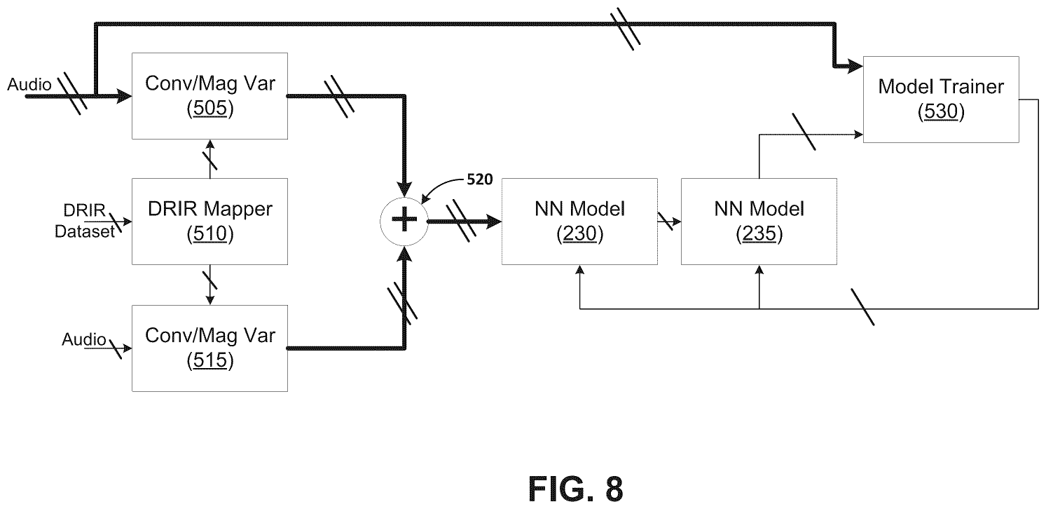

FIG. 8 illustrates another block diagram of a neural network training system according to an example implementation. FIG. 8 illustrates a modification of FIG. 5. However, FIGS. 5 and 6 can be similarly modified. FIG. 8 can be based on the system illustrated in FIG. 2B as well. As such, in some implementations, the NN model 230 can be configured to compress audio and the NN model 235 can be configured to decompress audio. As shown in FIG. 8, the neural network training system can include the convolution/magnitude variation 505 block, the directional room impulse response (DRIR) mapper 510 block, the convolution/magnitude variation 515 block, the summing 520 block, the NN model 230, and the model trainer 530 block. As shown in FIG. 8, the neural network training system can further include the NN model 235. In the illustration of FIG. 8, the thinner lines with a single slash indicate a single channel and the thicker lines with two slashes indicate multiple channels. The blocks described above may not be further described for the sake of brevity.

In some implementations, the objective can be to train the audio encoder and the audio decoder together. Therefore, the system of FIG. 5 can be modified such that the output of NN model 230 can be input to NN model 235. Such a modification is illustrated in FIG. 8. As shown in FIG. 8 the audio signal input to the convolution/magnitude variation 505 is further one of the inputs to the model trainer 530. Therefore, the audio signal input to the convolution/magnitude variation 505 can be used as the ground-truth for training the model.

The output of NN model 230 can be input to NN model 235 such that the output of the summing 520 is compressed and then decompressed. Therefore, the output of the NN model 235 can be a reconstructed representation of the audio signal input to the convolution/magnitude variation 505. The model trainer 530 can use a cost function to train both the NN model 230 and the NN model 235. In other words, the model trainer 530 can use a cost function to update coefficients associated with the NN model 230 and the NN model 235. The cost function can be configured to compare the reconstructed representation of the audio signal input to the convolution/magnitude variation 505 to the actual audio signal input to the convolution/magnitude variation 505. The least deviation between the two can represent a more optimally trained combination of the NN model 230 and NN model 235.

In some implementations, the data flow of FIG. 8 can be repeated until some criterion is met. For example, the data flow of FIG. 8 can be repeated until the cost function generates a value below (or, alternatively above) a threshold value. The threshold value can be pre-defined as, for example, an input value, a value in a memory, and the like.

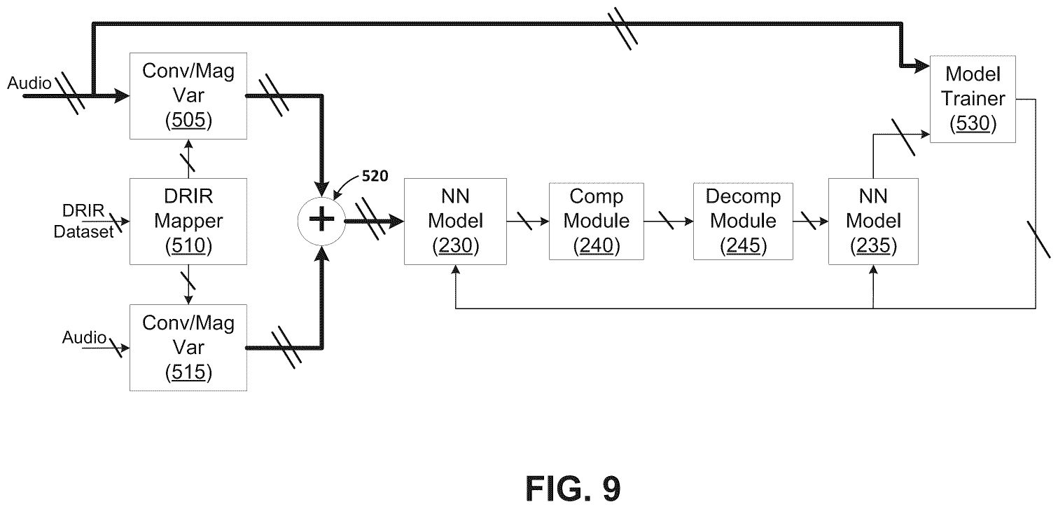

FIG. 9 illustrates another block diagram of a neural network training system according to an example implementation. FIG. 9 illustrates a modification of FIG. 5. However, FIGS. 5 and 6 can be similarly modified. FIG. 9 can be based on the system illustrated in FIG. 2C as well. As such, in some implementations, the NN model 230 may not be configured to compress audio and the NN model 235 may not be configured to decompress audio. As shown in FIG. 9, the neural network training system can include the convolution/magnitude variation 505 block, the directional room impulse response (DRIR) mapper 510 block, the convolution/magnitude variation 515 block, the summing 520 block, the NN model 230, and the model trainer 530 block. As shown in FIG. 9, the neural network training system can further include compression module 240, the decompression module 245, and the NN model 235. In the illustration of FIG. 9, the thinner lines with a single slash indicate a single channel and the thicker lines with two slashes indicate multiple channels. The blocks described above may not be further described for the sake of brevity.

In some implementations, the objective can be to train the audio encoder and the audio decoder together. Therefore, the system of FIG. 5 can be modified such that the output of NN model 230 can be input to NN model 235 via the compression module 240 and the decompression module 245. Such a modification is illustrated in FIG. 9. As shown in FIG. 9 the audio signal input to the convolution/magnitude variation 505 is further one of the inputs to the model trainer 530. Therefore, the audio signal input to the convolution/magnitude variation 505 can be used as the ground-truth for training the model.

The output of NN model 230 can be indirectly input to NN model 235 such that the output of the summing 520 is compressed and then decompressed by compression module 240 and the decompression module 245. Therefore, the output of the NN model 235 can be a reconstructed representation of the audio signal input to the convolution/magnitude variation 505. The model trainer 530 can use a cost function to train both the NN model 230 and the NN model 235. In other words, the model trainer 530 can use a cost function to update coefficients associated with the NN model 230 and the NN model 235. The cost function can be configured to compare the reconstructed representation of the audio signal input to the convolution/magnitude variation 505 to the actual audio signal input to the convolution/magnitude variation 505. The least deviation between the two can represent a more optimally trained combination of the NN model 230 and NN model 235.

In some implementations, the data flow of FIG. 9 can be repeated until some criterion is met. For example, the data flow of FIG. 9 can be repeated until the cost function generates a value below (or, alternatively above) a threshold value. The threshold value can be pre-defined as, for example, an input value, a value in a memory, and the like.

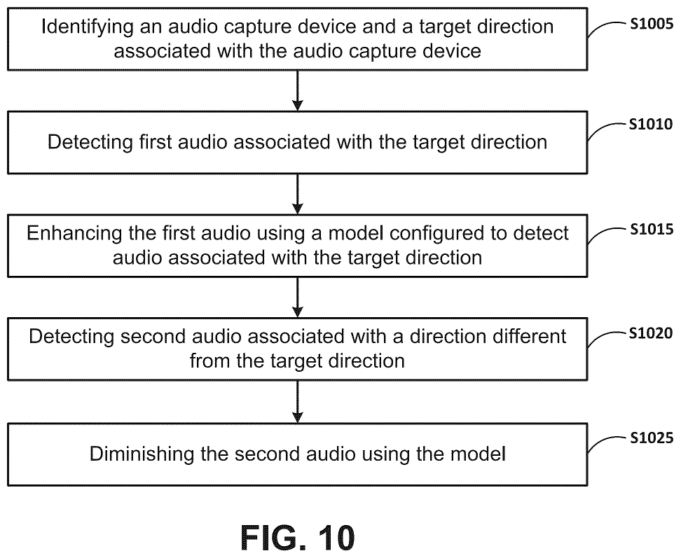

Example 1. FIG. 10 is a block diagram of a method of denoising audio according to an example implementation. As shown in FIG. 10, in step S1005 identifying an audio capture device and a target direction (e.g., a direction of interest with reference to an audio source) associated with the audio capture device. In step S1010, detecting first audio associated with the target direction. In step S1015, enhancing the first audio using a first model (sometimes called a machine learning model, a trained machine learning model, a machine learned model, a trained model, and the like) configured to detect audio associated with the target direction. In step S1020, optionally, detecting second audio associated with a direction different from the target direction. In step S1025, optionally, diminishing the second audio using a second model. In some implementations, the first model and the second model are a same model. In other words, the operations, functions, processes and the like of the first model and the second model are included in the same, a singular, one, and the like model.

Example 2. The method of Example 1, wherein diminishing the second audio can include decreasing an amplitude (e.g., the relative strength of sound waves) of at least one sound wave associated with the second audio, attenuating the second audio by reducing a signal strength (e.g., reducing power ratio in decibels (dB)) associated with the second audio, and/or eliminating the second audio by removing the second audio from an output of the machine learning model.

Example 3. The method of Example 1, wherein enhancing the first audio can include at least one of increasing the amplitude of the first audio, de-reverbing the first audio and de-noising the first audio.

Example 4. The method of Example 1, wherein the target direction can be associated with a focus region.

Example 5. The method of Example 1, wherein the model can be trained to detect the audio associated with the target direction using a directional room impulse response (DRIR) dataset.

Example 6. The method of Example 1, wherein the enhancing of the first audio using the model can include compressing the first audio using a first model and decompressing the compressed audio using a second model.

Example 7. The method of Example 1, wherein the model can be a neural network model, the neural network model can be configured to detect the audio associated with the target direction by training the neural network model, and training the neural network model can include receiving first training data including at least one first audio signal, receiving second training data including at least one second audio signal, receiving a directional room impulse response (DRIR) dataset, convolving the first training data with a first subset of the DRIR dataset as a first convolved audio, the first subset of the DRIR dataset being associated with the target direction, convolving the second training data with a second subset of the DRIR dataset as a second convolved audio, and training a neural network model based on the first convolved audio and the second convolved audio.

In some implementations, the neural network model can be further trained by a user in an environment that the audio capture device is being used. For example, a user can perform a secondary training operation to fine tune the directional detection or spatial detection of the neural network model. The secondary training operation can use first training data and second training data generated by the user in the environment that the audio capture device is being used.

Example 8. The method of Example 7, wherein training the neural network model can include training a first neural network model and a second neural network model, the first neural network model can be associated with compressing the first audio as compressed first audio, and the second neural network model can be associated with decompressing the compressed first audio.

Example 9. The method of Example 7, wherein the first training data can be associated with a focus region and the first subset of the DRIR dataset can represent an impulse response associated with the focus region.

Example 10. The method of Example 7 can further include applying a random gain variation to the first convolved audio.

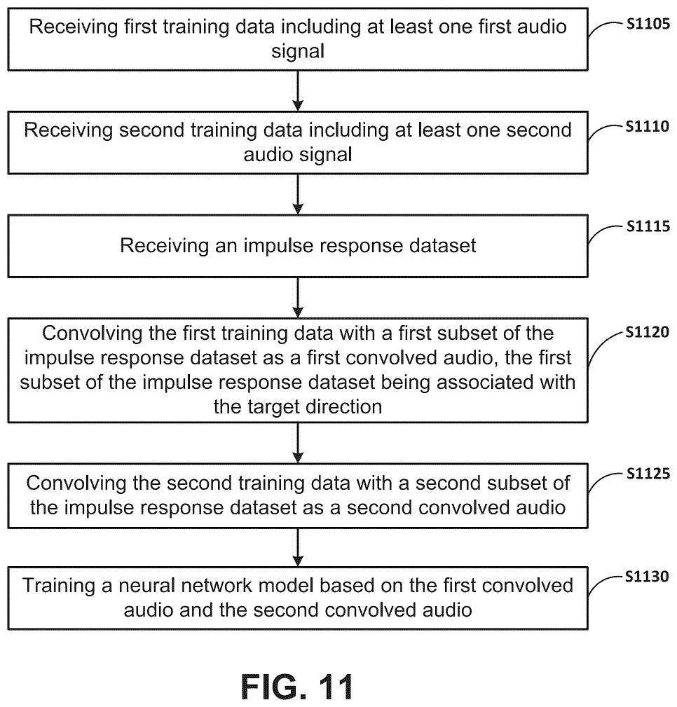

Example 11. FIG. 11 is a block diagram of a method of operating a neural network training system according to an example implementation. As shown in FIG. 11, in step S1105 receiving first training data including at least one first audio signal. In step S1110, receiving second training data including at least one second audio signal. In step S1115, receiving an impulse response dataset (e.g., a directional room impulse response (DRIR) dataset). In step S1120, convolving the first training data with a first subset of the impulse response dataset as a first convolved audio, the first subset of the DRIR dataset being associated with the target direction. In step S1125, convolving the second training data with a second subset of the impulse response dataset as a second convolved audio. In step S1130, training a neural network model based on the first convolved audio and the second convolved audio.

Example 12. The method of Example 11, wherein training the neural network model can include training a first neural network model and a second neural network model, the first neural network model can be associated with compressing the first audio as compressed first audio, and the second neural network model can be associated with decompressing the compressed first audio.

Example 13. The method of Example 11, wherein the first training data can be associated with a focus region and the first subset of the impulse response dataset can represent an impulse response associated with the focus region.

Example 14. The method of Example 11 can further include applying a random gain variation to the first convolved audio.

Example 15. A method can include any combination of one or more of Example 1 to Example 14.

Example 16. A non-transitory computer-readable storage medium comprising instructions stored thereon that, when executed by at least one processor, are configured to cause a computing system to perform the method of any of Examples 1-15.

Example 17. An apparatus comprising means for performing the method of any of Examples 1-15.

Example 18. An apparatus comprising at least one processor and at least one memory including computer program code, the at least one memory and the computer program code configured to, with the at least one processor, cause the apparatus at least to perform the method of any of Examples 1-15.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A method comprising:
identifying an audio capture device and a target direction associated with the audio capture device;
detecting first audio associated with the target direction; and
enhancing the first audio using a first machine learning model configured to detect audio associated with the target direction.

2. The method of claim 1, further comprising:
detecting second audio associated with a direction different from the target direction; and
diminishing the second audio using a second machine learning model.

3. The method of claim 2, wherein diminishing the second audio includes decreasing an amplitude of at least one sound wave associated with the second audio.

4. The method of claim 2, wherein diminishing the second audio includes attenuating the second audio by reducing a signal strength associated with the second audio.

5. The method of claim 2, wherein diminishing the second audio includes eliminating the second audio by removing the second audio from an output of the second machine learning model.

6. The method of claim 2, wherein the first machine learning model and the second machine learning model are a same machine learning model.

7. The method of claim 1, wherein enhancing the first audio includes increasing an amplitude of at least one sound wave associated with the first audio.

8. The method of claim 1, wherein enhancing the first audio includes de-reverbing the first audio by removing resonant frequencies from the first audio.

9. The method of claim 1, wherein enhancing the first audio includes de-noising the first audio by filtering the first audio.

10. The method of claim 1, wherein the target direction is associated with a focus region.

11. The method of claim 1, wherein the first machine learning model is trained to detect the audio associated with the target direction using an impulse response dataset.

12. The method of claim 1, wherein the enhancing of the first audio using the first machine learning model includes:
compressing the first audio using a first machine learning model; and
decompressing the compressed audio using a second machine learning model.

13. The method of claim 1, wherein
the first machine learning model is a neural network model,
the neural network model is configured to detect the audio associated with the target direction by training the neural network model, and
training the neural network model includes:
receiving first training data including at least one first audio signal;
receiving second training data including at least one second audio signal;
receiving an impulse response dataset;
convolving the first training data with a first subset of the impulse response dataset as a first convolved audio, the first subset of the impulse response dataset being associated with the target direction;
convolving the second training data with a second subset of the impulse response dataset as a second convolved audio; and
training the neural network model based on the first convolved audio and the second convolved audio.

14. The method of claim 13, wherein
training the neural network model includes training a first neural network model and a second neural network model,
the first neural network model being associated with compressing the first audio as compressed first audio, and
the second neural network model being associated with decompressing the compressed first audio.

15. The method of claim 13, wherein
the first training data is associated with a focus region, and
the first subset of the impulse response dataset represents an impulse response associated with the focus region.

16. A non-transitory computer-readable storage medium comprising instructions stored thereon that, when executed by a processor, are configured to cause a computing system to:
identify a audio capture device and a target direction associated with the audio capture device;
detect first audio associated with the target direction;
enhance the first audio using a machine learning model configured to detect audio associated with the target direction;
detect second audio associated with a direction different from the target direction; and
diminish the second audio using the machine learning model.

17. The non-transitory computer-readable storage medium of claim 16, wherein diminishing the second audio includes one of decreasing an amplitude of the second audio, attenuating the second audio, or eliminating the second audio.

18. The non-transitory computer-readable storage medium of claim 16, wherein enhancing the first audio includes at least one of increasing an amplitude of the first audio, de-reverbing the first audio and de-noising the first audio.

19. The non-transitory computer-readable storage medium of claim 16, wherein the target direction is associated with a focus region.

20. The non-transitory computer-readable storage medium of claim 16, wherein the enhancing of the first audio using the machine learning model includes:
compressing the first audio using a first machine learning model; and
decompressing the compressed audio using a second machine learning model.

21. The non-transitory computer-readable storage medium of claim 16, wherein
the machine learning model is a neural network model,
the neural network model is configured to detect the audio associated with the target direction by training the neural network model, and
training the neural network model includes:
receiving first training data including at least one first audio signal;
receiving second training data including at least one second audio signal;
receiving an impulse response dataset;
convolving the first training data with a first subset of the impulse response dataset as a first convolved audio, the first subset of the impulse response dataset being associated with the target direction;
convolving the second training data with a second subset of the impulse response dataset as a second convolved audio; and
training the neural network model based on the first convolved audio and the second convolved audio.

22. The non-transitory computer-readable storage medium of claim 21, wherein
training the neural network model includes training a first neural network model and a second neural network model,
the first neural network model being associated with compressing the first audio as compressed first audio, and
the second neural network model being associated with decompressing the compressed first audio.

23. An apparatus comprising:
at least one processor; and
at least one memory including computer program code;
the at least one memory and the computer program code configured to, with the at least one processor, cause the apparatus to:
identify a audio capture device and a target direction associated with the audio capture device;
detect first audio associated with the target direction;
enhance the first audio using a machine learning model configured to detect audio associated with the target direction;
detect second audio associated with a direction different from the target direction; and
diminish the second audio using the machine learning model.

24. The apparatus of claim 23, wherein
diminishing the second audio includes one of decreasing an amplitude of the second audio, attenuating the second audio, or eliminating the second audio, and
enhancing the first audio includes at least one of increasing an amplitude of the first audio, de-reverbing the first audio and de-noising the first audio.
